(19) United States
(12) Patent Application Publication
(10) Pub. No.: US 2007/0034622 A1
(43) Pub. Date: Feb. 15, 2007

(54) Heating device and use thereof

(76) Inventor: Daniel Ruminski, Chesterland, OH (US)

Correspondence Address: Justin S. Rerko & Associates, LLC, 19836 Ellsworth Drive, Strongsville, OH, 44149, US

(21) Appl. No.: 11/200,388

(22) Filed: Aug. 9, 2005

(51) Int. Cl. H05B 3/34

(52) U.S. Cl. 219/528; 219/202

(57) ABSTRACT

A heating device adapted to be disposed on or neat an automobile floor for producing a warmed substrate for the receipt of feet thereon. The heating device preferably is generally similar to a car mat, having a generally rubber-like body and additionally housing a heating element therein, preferably a resistance heating element. The device is adapted to couple to an automobile-based source of electricity and translate the received electricity into radiant heat.

### FIELD OF THE INVENTION

The present invention relates to a heating device and use thereof. More particularly, the present invention relates to a heating device adapted to be disposed along an automobile floor and provide a heated substrate for the positioning of feet thereon.

### BRIEF DISCUSSION OF THE RELATED ART

Substrates upon which individuals position their feet and/or other bodily parts, are often cold, especially relative to the ambient temperature of the area above and around the substrate. Typical substrates that suffer from such temperature disparities include, but are not limited to, those associate with automobiles, offices, camping tents, and the like.

Of particular relevance to the present invention, automobiles often have an interior that is of drastically variable temperature. For example, automobile seats are often cold, especially relative to the remainder of the interior of the automobile. Automobile manufacturers have attempted to mediate this temperature disparity through disposing selectably actuable heating elements within seats, so that a user thereof may enjoy a warmed seat as desired.

Floors, footwells and general areas in which users position their feet also suffer from temperature problems. Automobile manufacturers have attempted to mediate this aspect through positioning various forced air, temperature conditioning ducts to dispel warmed air on the floors and footwells. However, as known to one of ordinary skill in the art, such ducts are inefficient and ineffective in fully providing a warmed foot environment. For example, rigorous use of the forced air system can result in unwanted drain on an automobile's resources. By way of additional example, ducts often fail to fully distribute the warmed air, causing pockets of temperature gradients to occur. Additionally, ducts often direct forced air from above onto feet and legs, rather than radiating heat upward. This, along with the tendency of warm air to rise, often causes any temperature change created in the footwell to be ephemeral and short lasting, absent continuous, high powered use of the forced air system. Accordingly, what is needed is an automobile floor warming device that overcomes the limitations of the prior art.

### BRIEF SUMMARY OF THE INVENTION

In one aspect, the preset invention is directed to a heating device adapted to be disposed in a footwell of an automobile for providing a heatable automobile mat. The heating device generally includes a substantially planar body member having a first layer of material and a second layer of material associated therewith; a resistance heating element disposed between the body member first layer and second layer; and an electrical coupling, detachably associated with the resistance heating element, adapted to transfer electricity from a source of electricity to the resistance heating element.

In another aspect, the present invention is directed to a portable heating device adapted to be disposed in association with an automobile footwell and provide a heatable substrate for the positioning of an individual's feet thereon. The heating device suitably includes a flexible and substantially planar body member, a flexible heating element disposed within the body member; and an electrical coupling, associated with the heating element, adapted for coupling to a source of electricity and transmitting electricity to the heating element.

In yet another aspect, the present invention is directed to a portable heating device adapted to be disposed in association with an automobile footwell and provide a heatable substrate for the positioning of an individual's feet thereon. The heating device generally includes a body member having a top surface and a bottom surface; wherein the first surface comprises a plurality of raised portions claim 1, wherein the first surface comprises a plurality of raised portions adapted for increasing frictional engagement between an individual's foot and the first surface, and wherein the bottom surface comprises engagement means adapted for increasing engagement between the heating device and a substrate upon which it is disposed; a resistance heating element disposed between the body member first surface and bottom surface; and an electrical coupling, removably associated with the resistance heating element, adapted for coupling to a source of electricity and transmitting electricity to the resistance heating element.

### BRIEF DESCRIPTION OF THE DRAWINGS

These and other features and a more thorough understanding of the invention may be achieved my referring to the following description and claims, taken in conjunction with the accompanying drawings, wherein:

FIG. 1 is a perspective view of a heating device according to the present invention;

FIG. 2 is a perspective and partially cut away view of the heating device of FIG. 1; and

FIG. 3 is a perspective and partially cut away view of an alternate heating device according to the present invention.

### DETAILED DISCUSSION OF EXAMPLE EMBODIMENTS

Disclosed according to the present invention is a heating device and use thereof. More particularly, the present invention is directed to a heating device adapted to be positioned as an automobile (e.g., car, van, bus, RV, and the like) mat atop an automobile floor and thereby provide a warmed surface that is more comfortable for positioning an individual's feet thereon, such as, e.g., during driving. The device is generally provided as a rectangularly planar, flexible mat having a heating element, preferably a resistance heating element, disposed therein and is couplable to any of a plurality of sources of electrical power, such as conventional 120V AC wall outlets, batteries, cigarette adaptors, and the like.

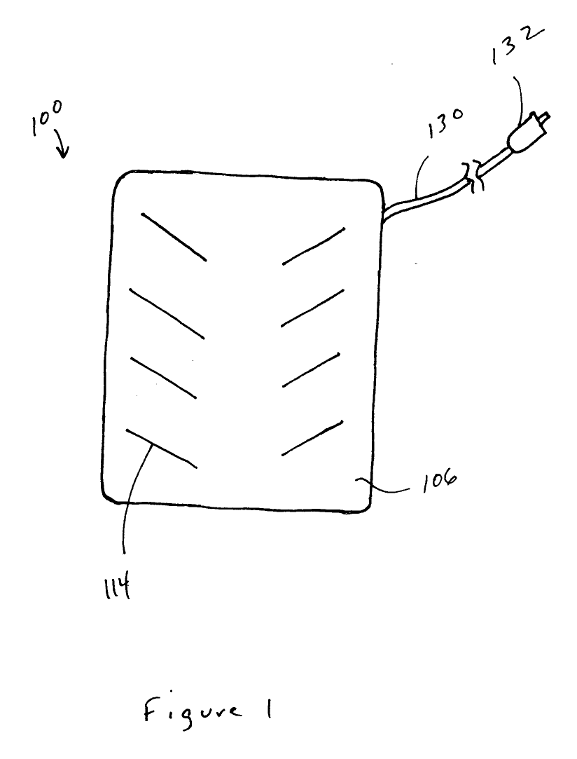

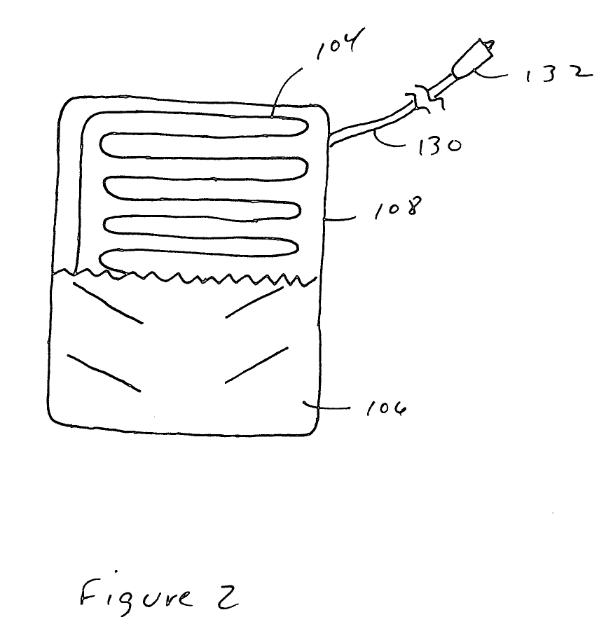

Turning to the Figures which illustrate example embodiments of the heating device 100 of the present invention, the heating device 100 is preferably a generally thin and generally planar member adapted to be disposed atop an automobile floor and thereby selectably transform an otherwise generally unheated and/or poorly heated automobile floor into a selectably warmed one that is more comfortable for positioning an individual's feet thereon. With reference to FIGS. 1 and 2, the heating device 100 of the present invention preferably includes a heating element 104, a top layer 106 of material disposed above the heating element 104, a bottom layer 108 of material disposed below the heating element 104, and control circuitry for, inter alia, coupling the heating device 100 to a source of electrical power. Preferably, the heating device 100 and its various components are fashioned of select materials that enable the device 100 to be at least somewhat flexible, thereby enabling the device 100 to be disposed atop various contours typically encountered in conventional automobiles.

In connection with a preferred embodiment, the heating element 104 of the preferred heating device 100 is provided as a resistance heating element adapted to convert electricity into heat as the radiant byproduct of applying resistance to the flow of electricity therethrough, as known to one of ordinary skill in the art. The heating element 104 is also preferably provided as an elongate heating wire sinuously disposed in the heating device 100, preferably between the top and bottom layers 106, 108 as will be more fully described hereinafter, in a manner that maximizes the amount of heating element 104 in the heating device 100 and accordingly also maximizes the heat output capacity of the device 100. Any suitable and conventional material may be employed in the construction of the heating element 104, such as, for example, copper, tin, lead, platinum, etc. and/or any alloy of the foregoing. Example commercially available heating elements potentially suitably for use in connection with the present invention include, but are not limited to, elements available from Calesco, those available under the tradename Performance Master Advantage Plus, and the like. Despite the disclosure of the preferred embodiment of the heating element 104 as a resistance heating element, it is to be appreciated that any appropriate heating element may be employed with the heating device 100 of the present invention, including, but not limited to, general electric heating elements, oil-based heating elements, and the like.

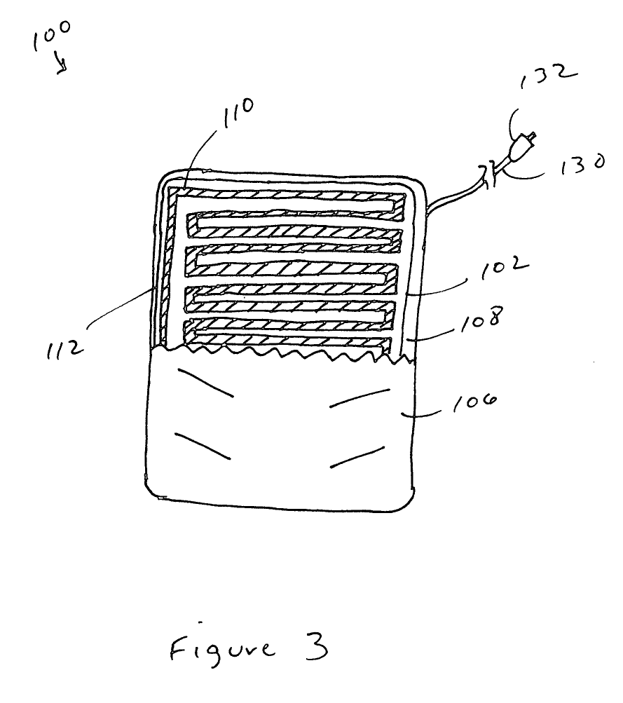

FIG. 3 illustrates an alternate heating element 102 that similarly employs resistance heating to produce heat. More specifically, FIG. 3 illustrates an example and preferred configuration of the portable heating device 100 in which the heating element 102 is disposed within the top and bottom layers 106, 108, and wherein a portion of the top layer 106 is removed to illustrate the heating element 102 therein. The heating element 102 is suitably provided as a printed circuit-like heating element 102 having a plurality of electricity transmission-capable circuits 110 (e.g., a base dielectric material coupled to a resistor) disposed and/or printed on a substrate 112. The circuits 110 are provided as any of a known plurality of circuits (e.g., copper circuits, and the like) adapted to permit the transmission of electricity therethrough. The circuits 110 may suitably be disposed and/or printed on the substrate 112, or may suitably be associated with one or more of the layers 106, 108. The circuits 110 are preferably associated with one or more termination points (not illustrated) for coupling the circuits 110 to a source of electrical power.

The substrate 112 is generally an element of the device 100 adapted to receive and support the circuits 110 thereon Any suitable material may be employed for construction of the substrate 112, such as, for example, carbon steel, stainless steel (e.g., 304, 316, 340, etc.), ceramic (e.g., mullite, alumina, aluminum nitride, steatite, Macor™, etc.), quartz, pyrex, PVC, PET, aluminum, mylar, beryllium oxide, silicon nitrate, glass, and the like. In a preferred embodiment, the circuits 110 are disposed and/or printed on a mylar substrate 112, thereby configuring the heating device 100 as a flexible heating device 100, given the flexibility of both the printed circuits 110 and the mylar substrate 112. Example suitable printed circuit-like heating elements 112 include, for example, those available from Chromalox (Pittsburgh, Pa.), those available from Illinois Tool Works, and the like.

Further to the printed circuit-like heating element 102 embodiment, the circuits 110 may suitably be provided as a plurality of parallel circuits, each of which may suitably also include an independent control for the flow of electricity thereto. Provisioning the heating element 102 into a plurality of separately controllable circuits 110 suitably enables the heating device 100 to operate at a number of heat output levels. Thus, for example, if the circuits 110 are provided as two parallel circuits and electricity is delivered to one of the circuits, a certain amount of heat will be produced; similarly, if electricity is delivered to both circuits, the amount of heat produced will approximately be double relative to the amount produced by one circuit. Accordingly, the heating device 100 may suitably include a user interface (not shown) that enables a user to select an amount of heat to be output by the device. For example, the user interface may include a switch or similar means alternateable between a “high” position and a “low” position. Further thereto, positioning of the switch to the “high” position suitably directs electricity to flow through both circuits; likewise, positioning of the switch to the “low” position suitably directs electricity to flow through one of the circuits, thereby producing relatively less heat output. It is to be appreciated that any number of circuits may be provided, with regard given to the particular application of the heating device 100. Additionally, it is to be also appreciated that the user interface is an optional element and, if present, may be provided as any suitable device, such as a rheostat for enabling a user to more precisely control the amount of heat being output by the device 100, and the like.

The heating device 100 of the present invention suitably also includes the top layer 106 and the bottom layer 108, which collectively generally operate as a resilient casing for the heating element 104/102. The top layer 106 is preferably a member of the device 100 disposed atop the heating element 104 and is generally adapted to provide a substrate upon which an individual may position his/her feet while sitting in an automobile. The bottom layer 108 is preferably a member of the device 100 disposed below the heating element 104 and is adapted to securely engage a substrate (e.g., floor) upon which the device 100 is positioned. In a preferred embodiment, the top layer 106 and the bottom layer 108 are provided as generally planar members disposed relative to each other in a suitably parallel relationship.

The top layer 106 is preferably a substantially planar and thin member disposed atop the heating element 104 and is adapted to, inter alia, provide a substrate for the positioning of an individual's feet. The top layer 106 generally includes a top surface and a bottom surface. The top surface is preferably a surface of the device 100 oriented as a top of the device 100 and is maintained in spaced apart relationship to the heating element 104/102. The bottom surface is preferably a surface of the device 100 maintained in generally abutting relationship to the heating element 104/102. The top surface of the top layer 106 may suitably include various features thereon for increasing the functionality of the device 100 as a foot substrate. For example, the top surface may suitably include one more rib-like raised portions 114 thereon for increasing frictional engagement with a foot and resisting slippage of the same relative to the device 100. By way of additional example, the top surface may additionally include a raised, shoulder-like portion disposed perimetrically about the same, or one or more recessed portions, so as to generally configure the device 100 to be adapted to retain water, snow and the like thereon. As apparent, individuals typically traffic water and similar items onto conventional car mats. Through the present invention, water so trafficked onto the device 100 suitably becomes evaporated through action of the heating element 104/102. Accordingly, the presence of the shoulder-like portion and/or recessed portions suitably ensure that any water so trafficked will remain on the device 100 until evaporated, rather than running onto and potentially damaging peripheral automobile components.

The bottom layer 108 is preferably a substantially planar member disposed below the heating element 104 and is adapted to securely engage a floor of an automobile upon which the device 100 is disposed. The bottom layer 108 generally includes a bottom surface, a top surface and, optionally, a means for securely engaging the floor of the automobile. The bottom surface is preferably a surface of the device 100 oriented as a bottom of the device 100, maintained in spaced apart relationship to the heating element 104, and adapted to associate with the floor. The top surface is preferably a surface of the device 100 generally unexposed when the device 100 is fully assembled and is maintained in generally abutting relationship to the heating element 104.

The bottom surface of the bottom layer 108 suitably and optionally also includes the means for securely engaging the floor so as to prevent slippage of the device 100 relative thereto. The engaging means is preferably provided as a component that is adapted to interface with any and/or all of the potential substrates upon which the device 100 may be positioned, such as a carpeted floor, a floor having plastic or similar covering thereon, and the like. In connection with a preferred embodiment, the bottom layer 108 engaging means may suitably be provided as a plurality of rubber feet-like members, preferably provided in a frustro-conical and/or pointed shape, which are suitably adapted to interface with a plurality of substrates. Additionally, the feet 120 may suitably be integrally associated with the bottom surface, be removably associated therewith, or in any other suitable configuration. Furthermore, the bottom layer 108 engaging means may be provided as any feature sufficient for engaging the device 100 with the floor, such as a tacky adhesive, projecting tine-like barbs (especially useful in connection with floors), and the like.

In an additional embodiment, the heating device 100 may suitably be configured as a reversible heating device 100. More specifically, the top surface of the top layer 106 and the bottom surface of the bottom layer 108 may suitably be provided as substantially identical elements. Accordingly, if a user so desires, the user may suitably position and use the device 100 with the top layer 106 thereof exposed as a foot substrate, and then, as desired, may suitably invert the device 100 so that the bottom layer 108 thereof is exposed as a foot substrate. The top layer 106 and bottom layer 108 may suitably include any and all features as necessary to implement proper reversibility of the same. For example, both the top layer 106 and the bottom layer 108 may include a plurality of projecting members thereon, which members suitably operate to maintain the device 100 in position atop a floor and also operate to prevent slippage of an individual's foot relative thereto.

In one aspect, the optional reversible nature of the device 100 suitably enables an individual to reverse the device 100 in the case wherein one of the layers is soiled or otherwise unattractive in appearance. In another aspect, the top layer 106 and bottom layer 108 may suitably be of dissimilar appearances and/or configurations. For example, the bottom layer 108 may suitably be provided of a generally rubber-like configuration, as previously described, while the top layer 106 may suitably include a layer of carpeting or similar feature thereon (optionally atop a layer of rubber or similar material defining the top layer 106). Accordingly, the user may select whether the user wishes to display a carpeted device 100 or a rubberized device 100, without requiring the user to choose between two different devices 100. The use of carpeting as a layer atop the top layer 106 may be advantageous in connection with increasing the aesthetic appeal of the device 100 as disposed within an automobile.

In a preferred embodiment, the bottom layer 108 may suitably include a reflective member thereon for focusing the dissipation of heat from the heating element 104 upward, generally to and through the top layer 106. The reflective member is preferably disposed between the heating element 104 and the bottom layer 108, and is more preferably disposed atop the top surface of the bottom layer 108, and may preferably be constructed of any appropriate material, such as, for example, a foil-like material, such as aluminum, and operates to direct the radiation of heat from the heating element 104 upward.

In connection with a preferred embodiment, the heating device 100 top layer 106 and the bottom layer 108 are preferably constructed from any suitable flexible and durable material, preferably also an electrically insulating material. Suitable example materials for the construction of the top 106 and bottom 108 layers include, but are not limited to, vinyl (e.g., Duraflex™, available from Duraflex, Tewkesbury, England), acrylonitrile-butadiene-styrene(ABS) plastic, polyvinylchloride (PVC), polyarylate, polycarbonate, high density polyethylene (HDPE), acrylic-styrene-acrylonitrile (ASA), polystyrene (PS), styrene-acrylonitrile (SAN), polyarylsulfone, general laminates, a general rubber, and any suitable heat transferable and preferably electricaly insulated material. However, it is to be appreciated that the layers 106, 108 may suitably be constructed from any other appropriate material, with suitable regard given to the requirements of the device 100.

As previously discussed, the heating element 104/102 is preferably disposed between the top layer 106 and the bottom layer 108, preferably as illustrated in FIGS. 2 and 3. More preferably, one surface of the heating element 104/102 is disposed along the top surface of the bottom layer 108 and another surface of the heating element 104 is disposed along the bottom surface of the top layer 106, in a manner that generally sandwiches the heating element 104/102 between the layers 106, 108. The heating element 104/102 may suitably be associated with the layers 106, 108 through an appropriate fastening member, such as adhesive, glue, mechanical, clamp-like fasteners, and the like. Alternatively, the heating element 104/102 may suitably not be fastened to the layers 106, 108, and may be maintained therein by virtue of the layers 106, 108 being fastened to each other through appropriate adhesives, glues and the like. Even more preferably, the layers 106, 108 are associated with each other in a waterproof and impervious manner that prevents introduction of water to the heating element 104/102.

The heating device 100 of the present suitably also includes the control circuitry for, inter alia, coupling the heating device 100 to a source of electrical power. Preferably, the control circuitry provides a number of features. For example, the control circuitry couples the heating device 100, particularly the heating element 104, to the source of electrical power. By way of additional example, the control circuitry also provides a means for selectably passing the electrical power to the heating device 100. By way of yet another example, the control circuitry also provides certain features that protect the device 100 against harmful electrical operation.

In connection with a preferred embodiment, the heating device 100 is preferably couplable to a source of electrical power through a conventional electric cord 130 electrically associated with the heating device 100 in a well known manner. The electric cord 130 preferably includes at one end a plug adaptor 132 adapted to be connected to a source of electric current, e.g., an automobile-based cigarette lighter adaptor, 120V AC, one or more batteries, etc. The electrical cord 130 is preferably provided in substantial length to facilitate positioning of the heating device 100 in any desired position. The electrical cord 130 may suitably be retractable into the heating device 100 to simplify storage of the device 100 and to reduce the amount of unneeded cord 130 being exposed from the device 100.

In an alternate embodiment, the electrical cord 130 may suitably be detachably associable with the heating device 100. In one aspect, such detachability suitably facilitates storage and/or manipulation of the device 100. In another aspect, such detachability suitably provides a safety feature should an individual's foot accidentally become entangled with the cord 130 while the device 100 is positioned in an automobile as a heating mat. For example, if the device 100 is positioned in an automobile foot well and the cord 130 is associated with an automobile cigarette lighter adaptor receptacle, the detachability ensures that should an individual's leg become intertwined with the cord 130, the cord 130 will release from the device 100 and thereby prevent accidental movement of the device 100, or other undesirable complications.

With further reference to detachably associated electrical cord 130 embodiment, the electrical cord 130 may be detachably associable with the device 100 in any of a plurality of manners and configurations. In one embodiment, the electrical cord 130 may suitably generally comprise two components, namely a first stretch of cord 130 that is integrally associated with the device 100 and which terminates in either a male or a female connector, and a second stretch of cord that, on one end, includes a connector component complementary to the first stretch of cord connector, and, on the other end, an interface for an electrical connection (e.g., a cigarette lighter adaptor).

In connection with a preferred embodiment, the heating device 100 is adapted for automobile-based use. Accordingly, the plug adaptor 132 that terminates from the electric cord 130 is preferably provided as a conventional cigarette lighter adaptor adapted to be disposed in an automobile cigarette lighter adaptor receptacle and to transfer electricity therefrom to the device 100.

In connection with yet another embodiment, the heating device 100 of the present invention may suitably be hard wired to an automobile-based source of electricity. In this embodiment, the heating device 100 does not require association with a source of electricity in an obtrusive manner (e.g., being associated with a cigarette lighter adaptor receptacle) and more seamlessly integrates into the interior of an automobile. Further, in the embodiment in which the device 100 is hard wired to an automobile, the electric cord 130 is preferably removably associable with the heating device 100 so as to enable the heating device 100 to be removed from the automobile for, e.g., cleaning and the like. One or more controls for the device 100, aspects of which will be discussed hereinafter, may suitably be associated with various control panels of the automobile. Additionally, the heating device 100 need not be a separate element and may suitably be permanently installed in the floor of the automobile, particularly with the heating element 104/102 thereof being disposed beneath the carpeting or other floor covering of an automobile.

In connection with still another embodiment, the electric cord 130 may suitably terminate in a generally universal adaptor adapted to selectably interface with any of a plurality of electrical interfaces. For example, it may be desirable to configure the device 100 to simultaneously operate as an automobile-based heater and as an office or similar dwelling structure environment heater. Accordingly, the electric cord 130 adaptor may be configured to interface with a cigarette lighter adaptor for automobile use and then with a conventional male plug adaptor (for plugging into a conventional wall outlet) for dwelling structure use.

In connection with another preferred embodiment, the electric cord 130 of the heating device 100 may preferably be provided as a substantially flat, ribbon-like member. Because the heating device 100 is configured to be positioned on a floor or similar substrate, the use of a substantially flat electric cord 130 suitably reduces the size profile of the device 100 and reduces the amount of physical intrusion of the cord 130 into its environment. The flat cord 130 suitably also enables the cord 130 to be run under other rugs and/or mats, without physically distorting the same. Additionally, the cord 130 may suitably terminate in a GFCI (ground-fault circuit interrupter) adaptor for ensuring proper flow of electrical power to the heating device 100, especially in connection with dwelling structure-based use.

Despite disclosure of a preferred embodiment of the heating device 100 in which it is couplable to a source of electric power associated with a conventional wall outlet, it is to be appreciated that the heating device 100 may suitably be configured to be coupled to any of a plurality of electric sources. In connection with one embodiment, the device 100 may suitably be configured to couple to an electrochemical, battery, solar cell, and/or fuel cell-like source of electrical power. The control circuitry of the device 100 may also include any other features and/or element, such as transformers, generators, rectifiers for enabling the heating device 100 to operate with any of a plurality of sources of electric power, particularly those involving low voltage and/or being generally dissimilar to that encountered with conventional 120V AC wall outlets.

The control circuitry of the heating device 100 suitably also includes means adapted for selectably passing electric power from the source of electric power to the heating device 100. Preferably, the means operates to allow the device 100 to be continuously coupled to a source of electric power and to pass electric power to the device 100 only upon actuation of a suitably actuation means. The means may suitably be provided as any conventional circuit breaker-like means adapted to create a circuit between the source of electric power and the heating device 100 upon suitably actuation. For example, the means may suitably be provided as a user interface, such as a conventional switch, pushbutton, rotary dial, slidable mechanism, and the like, adapted to be alternated between an on state, in which electricity flows to the heating device 100, and an off state, in which electricity is prevented from flowing to the heating device 100.

Additionally, the control circuitry may also include a means adapted for receiving user selection of a desired temperature. For example, such a means may be provided as a rotary dial that enables a user to select one of a range of available temperatures for the heat output by the heating device 100. Additionally, the control circuitry may include a switch for alternating operation between a relatively high level of heat output (for directing operation at approximately 140 degrees F.) and a relatively low level of heat output (for directing operation at approximately 100 degrees F.). Such means may be provided by any well known device and electrically associated with the heating mat in any appropriate manner.

The control circuitry may additionally comprise means adapted for providing certain information to the user. For example, the interface may include means adapted for informing the user when the heating device 100 is active and emitting heat. Such means may include, for example, a light emitting diode (“LED”) coupled to the control circuitry and adapted to be illuminated when current is passing to the heating device 100. Additionally, the LED may suitably be positioned in proximity to a written indicium, such as a “heating” indicium that enables a user to readily understand the information being conveyed by the LED. Additional information providing means may be provided, such as an LED adapted to inform when the device is in a cool down mode, etc. In a preferred embodiment, the LED may suitably be disposed on and/or be associated with the electric cord 130, even more preferably the plug adaptor 132.

The control circuitry suitably also includes protective elements adapted for governing various aspects of the operation of the heating device 100. For example, the control circuitry may additionally comprise a temperature cutoff switch, such as a bimetallic over temperature cutoff switch, having a temperature sensor adapted to sense the temperature of the heating device 100 and/or the environment of the heating device 100. The switch is a conventional switch, preferably responsive to a preselected temperature value and adapted to prevent the flow of current to the heating device 100 upon attainment of the preselected temperature value. Preventing the flow of current under these conditions suitably prevents overheating and possible damage to components near to the heating device 100 and/or the heating device 100. Other components may additionally be associated with the control circuitry, such as ground fault circuit interrupter (GFCI) components, general components adapted for resisting the deleterious impact of water, and the like. Although the invention has been described with regard to certain preferred example embodiments, it is to be understood that the present disclosure has been made by way of example only, and that improvements, changes and modifications in the details of construction and the combination and arrangement of parts may be resorted to without departing from the spirit and scope of the invention. Such improvements, changes and modifications within the skill of the art are intended to be covered by the scope of the appended claims.

What is claimed is:

1. A heating device adapted to be disposed in a footwell of an automobile for providing a heatable automobile mat, wherein the heating device comprises:
a substantially planar body member having a first layer of material and a second layer of material associated therewith;
a resistance heating element disposed between the body member first layer and second layer; and
an electrical coupling, detachably associated with the resistance heating element, adapted to transfer electricity from a source of electricity to the resistance heating element.

2. The heating device of claim 1, wherein the resistance heating element comprises a resistance heating wire sinuously disposed between the body member first layer and second layer.

3. The heating device of claim 1, wherein the resistance heating element comprises a flexible resistance heating element.

4. The heating device of claim 3, wherein the resistance heating element comprises an etched foil, printed circuit-like resistance heating element.

5. The heating device of claim 1, wherein the body member first layer comprises a plurality of raised portions adapted for increasing frictional engagement between an individual's foot and the first layer.

6. The heating device of claim 5, wherein the body member second layer comprises engagement means adapted for increasing engagement between the heating device and a substrate upon which it is disposed.

7. The heating device of claim 6, wherein the engagement means comprises a plurality of tine-like barbs projecting from the body member second layer and adapted to securely interface with the substrate upon which the heating device is disposed.

8. The heating device of claim 1, wherein the electrical coupling comprises an electrical cord, wherein the electrical cord comprises a first end integrally associated with the resistance heating element and a second end comprising coupling means adapted for coupling to a source of electricity.

9. The heating device of claim 8, wherein the electrical cord coupling means comprises a cigarette lighter adaptor adapted to couple to a cigarette lighter adaptor receptacle and transfer electricity therefrom to the resistance heating element.

10. The heating device of claim 9, wherein the electrical cord further comprises a breakaway means, disposed between the first end and the second end, and wherein the breakaway means is adapted to permit separation of the first end from the second end responsive to an application of a separating force thereon.

11. The heating device of claim 1 further comprising a user interface including heat output selection means, operably associated with the resistance heating element, adapted for permitting a user to select a desired level of heat to be output by the resistance heating element.

12. The heating device of claim 11, wherein the heat output selection means comprises a switch alternateable between a first position, corresponding to a relatively high level of heat output, and a second position, corresponding to a relatively low level of heat output.

13. The heating device of claim 11, wherein the user interface further comprises a LED adapted to emit a light in response to electricity being supplied to the resistance heating element.

14. A portable heating device adapted to be disposed in association with an automobile footwell and provide a heatable substrate for the positioning of an individual's feet thereon, wherein the heating device comprises:
a flexible and substantially planar body member,
a flexible heating element disposed within the body member; and
an electrical coupling, associated with the heating element, adapted for coupling to a source of electricity and transmitting electricity to the heating element.

15. The heating device of claim 14, wherein the electrical coupling is removably associated with the heating element.

16. A portable heating device adapted to be disposed in association with an automobile footwell and provide a heatable substrate for the positioning of an individual's feet thereon, wherein the heating device comprises:
a body member having a top surface and a bottom surface; wherein the first surface comprises a plurality of raised portions claim 1, wherein the first surface comprises a plurality of raised portions adapted for increasing frictional engagement between an individual's foot and the first surface, and wherein the bottom surface comprises engagement means adapted for increasing engagement between the heating device and a substrate upon which it is disposed;
a resistance heating element disposed between the body member first surface and bottom surface; and
an electrical coupling, removably associated with the resistance heating element, adapted for coupling to a source of electricity and transmitting electricity to the resistance heating element.

17. The portable heating device of claim 16, wherein the electrical coupling comprises a breakaway means, disposed between a first end and a second end of the electrical coupling, adapted to permit separation of the first end from the second end responsive to application of a separating force thereon.

18. The portable heating device of claim 17, wherein the electrical coupling further comprises a cigarette lighter adaptor, associated with the second end thereof, adapted to couple to a cigarette lighter adaptor receptacle.

19. The portable heating device of claim 17 further comprising heat output selection means, alternateable between a high level and a low level, adapted for directing operation of the heating element at a desired heat output level.

20. The portable heating device of claim 17 further comprising information providing means adapted to provide information indicative of an operational state of the heating device.
